(19) United States
(12) Patent Application Publication
(10) Pub. No.: US 2025/0294128 A1
(43) Pub. Date: Sep. 18, 2025

(54) VIDEO DATA PROCESSING METHOD AND ELECTRONIC DEVICE

(71) Applicant: GUANGDONG OPPO MOBILE TELECOMMUNICATIONS CORP., LTD., Dongguan (CN)

(72) Inventor: Zhiyao YANG, Dongguan (CN)

(21) Appl. No.: 19/224,563

(22) Filed: May 30, 2025

Related U.S. Application Data
(63) Continuation of application No. PCT/CN2023/123948, filed on Oct. 11, 2023.

(30) Foreign Application Priority Data
Dec. 13, 2022 (CN) 202211604312.4

(51) Int. Cl. H04N 13/167; H04N 13/106; H04N 13/156; H04N 13/194; H04N 13/282; H04N 23/63

(52) U.S. Cl. CPC H04N 13/167; H04N 13/156; H04N 13/158; H04N 13/194; H04N 13/282; H04N 23/632

(57) ABSTRACT

The present application provides a video data processing method and an electronic device. The video data processing method is applied to a first device establishing a communication connection with a second device. The method includes encapsulating a video content captured by the first device to obtain a first video stream; receiving a second video stream sent by the second device, the second video stream being obtained by encapsulating a video content captured by the second device; and parsing and synchronizing the first video stream and the second video stream to generate multi-view video data.

### CROSS REFERENCE TO RELATED APPLICATIONS

This application is a continuation of International Patent Application No. PCT/CN2023/123948, filed Oct. 11, 2023, which claims priority to Chinese Patent Application No. 202211604312.4, filed Dec. 13, 2022, the entire disclosures of which are incorporated herein by reference.

### TECHNICAL FIELD

The present disclosure relates to the technical field of multimedia technologies, in particular, to a video data processing method and an electronic device.

### BACKGROUND

With the development of technologies of intelligent terminals such as mobile phones or the like, the intelligent terminals such as mobile phones or the like are increasingly applied to various shooting scenarios.

### SUMMARY

The present disclosure provides a video data processing method and an electronic device.

In a first aspect, the embodiments of the present disclosure provide a video data processing method. The method is applied to a first device establishing a communication connection with a second device. The method includes: encapsulating a video content captured by the first device to obtain a first video stream; receiving a second video stream sent by the second device, the second video stream being obtained by encapsulating a video content captured by the second device; and parsing and synchronizing the first video stream and the second video stream to generate multi-view video data.

In a second aspect, the embodiments of the present disclosure provide a video data processing method. The method is applied to a second device establishing a communication connection with a first device. The method includes: encapsulating a video content captured by the second device to obtain a second video stream; and transmitting the second video stream to the first device, the second video stream being configured, together with a first video stream of the first device, to generate multi-view video data through parsing and synchronizing, where the first video stream is obtained by encapsulating a video content captured by the first device.

In a third aspect, the embodiments of the present disclosure provide an electronic device including a processor and a memory. The memory stores a computer program, and the processor is configured to execute the video data processing method of encapsulating a video content captured by a first device to obtain a first video stream; receiving a second video stream sent by a second device, the second video stream being obtained by encapsulating a video content captured by the second device; and parsing and synchronizing the first video stream and the second video stream to generate multi-view video data by calling the computer program.

### BRIEF DESCRIPTION OF THE DRAWINGS

To more clearly illustrate the technical solutions in the embodiments of the present disclosure, a brief introduction to the drawings used in some embodiments of the present disclosure is provided below. It is evident that the drawings described below are only some of the embodiments of the present disclosure. For those skilled in the art, additional drawings may be derived from these drawings without creative work.

FIG. 1 is a schematic flowchart of a video data processing method according to some embodiments of the present disclosure.

FIG. 2 is a schematic scenario view of a video data processing method according to some embodiments of the present disclosure.

FIG. 3 is a schematic view of a positional relationship of viewpoints of a plurality of devices in a video data processing method according to some embodiments of the present disclosure.

FIG. 4 is a schematic view of a method of aligning first video data and second video data according to some embodiments of the present disclosure.

FIG. 5 is a schematic view of a representation of a relative positional relationship between a first device and a second device according to some embodiments of the present disclosure.

FIG. 6 is a schematic scenario view of triggering a viewpoint switching instruction according to some embodiments of the present disclosure.

FIG. 7 is a schematic scenario view of triggering a viewpoint switching instruction according to some embodiments of the present disclosure.

FIG. 8 is a schematic flowchart of a video data processing method according to some embodiments of the present disclosure.

FIG. 9 is a schematic structural view of a video data processing apparatus according to some embodiments of the present disclosure.

FIG. 10 is a schematic structural view of a video data processing apparatus according to some embodiments of the present disclosure.

FIG. 11 is a schematic structural view of an electronic device according to some embodiments of the present disclosure.

FIG. 12 is a schematic structural view of an electronic device according to some embodiments of the present disclosure.

### DETAILED DESCRIPTION

The technical solutions in some embodiments of the present disclosure will be clearly and completely described below with reference to the accompanying drawings. It is evident that the described embodiments are only part of the embodiments of the present disclosure and not all embodiments. Based on the embodiments of the present disclosure, all other embodiments obtained by those skills in the art without any creative work fall within the scope of the present disclosure.

As referred to herein, “embodiment” means that a specific feature, structure, or characteristic described in connection with the embodiment may be included in at least one embodiment of the present disclosure. The appearance of the phrase in various places in the specification are not necessarily all referring to the same embodiment, nor are they mutually exclusive alternative embodiments. It is explicitly and implicitly understood by those skills in the art that the embodiments described herein may be combined with other embodiments.

Some embodiments of the present disclosure provide a video data processing method. An execution subject of the video data processing method may be a video data processing apparatus provided in some embodiments of the present disclosure, or an electronic device integrated with the video data processing apparatus. The video data processing apparatus may be implemented in a hardware manner or a software manner.

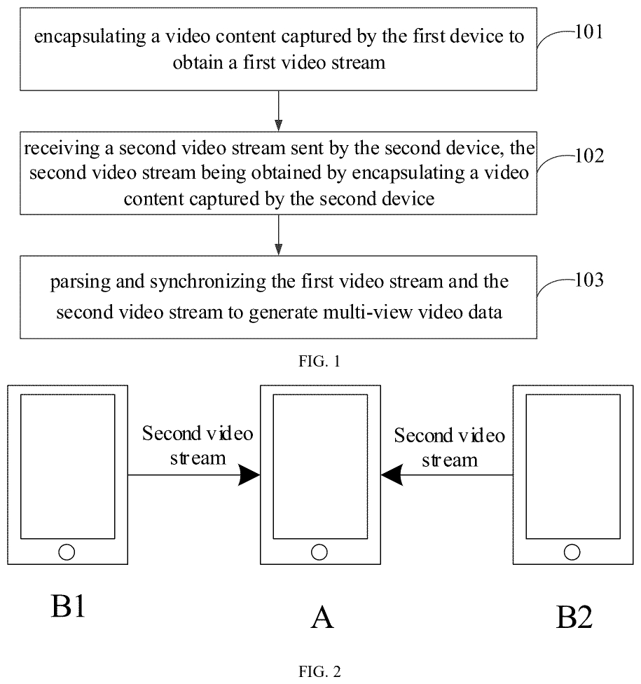

As shown in FIG. 1, FIG. 1 is a schematic flowchart of a video data processing method according to some embodiments of the present disclosure. The video data processing method provided in some embodiments of the present disclosure may include operations executed by the following blocks.

At block 101, a video content captured by a first device may be encapsulated to obtain a first video stream.

With the development of technologies of intelligent terminals such as mobile phones or the like, the intelligent terminals such as mobile phones or the like are increasingly applied to various shooting scenarios. However, current intelligent terminals lack a function of capturing multi-view videos.

In some embodiments of the present embodiment, an execution subject may be the first device. The first device and a second device may both be electronic devices having a capturing function and a video processing function. The electronic devices may be smart phones, tablet computers, handheld computers, etc. For example, the first device and the second device may both be mobile phones, tablet computers, etc.

The first device may serve as a host. The host may provide a service. At least one second device may serve as an auxiliary device. A number of the second device may be set according to the actual shooting needs of the user.

The first device may establish a communication connection with the second device, so that the first device may receive a video stream transmitted from the second device. There may be various ways for the first device and the second device to establish a communication connection. In some embodiments, the first device and the second device may be connected to a same local area network. For example, the first device and the second device may be connected to the same Wi-Fi hotspot.

For example, in some embodiments, before encapsulating the video content captured by the first device to obtain a first video stream, the method may further include the following operations.

One or more devices connected to the same network hotspot as the first device may be searched for, and one or more found devices may be displayed on a user display interface. In response to a selection operation from the user, one or more devices indicated by the selection operation may be determined from the one or more found devices that are displayed as the second device.

In some embodiments, after connecting the first device and the second device to the same Wi-Fi hotspot, the user may view the devices connected to the same Wi-Fi in the user interface of the first device and select the second device from them.

In some embodiments, the user may log in to a server with the same account on both the first device and the second device, so that the first device and the second device may establish a connection through the server and perform data transmission through the server.

An example is given in which both the first device and the second device are mobile phones. Suppose a user needs to capture multi-view video data of a certain scene, the user may place one of a plurality of mobile phones at each of a plurality of different positions in the scene and point a camera of each of the plurality of mobile phones at a target to be captured. One of the plurality of mobile phones may be set as the host (first device), and the other mobile phone or mobile phones apart from the host may be determined as auxiliary devices (one second device or a plurality of second devices). The user may activate a video recording function of the first device and the second devices respectively as needed to perform video capturing.

The first device, after starting video recording, may perform video capturing and encapsulate the captured video content to obtain the first video stream. That is, the first device may perform video acquisition, compression, and streaming processing to obtain first video stream data.

At block 102, a second video stream sent by the second device may be received, where the second video stream may be obtained by encapsulating a video content captured by the second device.

The second device, after starting video recording, may perform video capturing and encapsulate the captured video content to obtain the second video stream. That is, the second device may perform video acquisition, compression, and streaming processing to obtain second video stream data. Then, the second device may transmit the second video stream to the first device in real time.

At block 103, the first video stream and the second video stream may be parsed and synchronized to generate multi-view video data.

The first video stream captured by the first device may be stored locally. The first device may receive the second video stream transmitted by the second device, and then parse and synchronize the first video stream and the second video stream to generate the multi-view video data.

In some embodiments, in order to reduce a time delay between a plurality of video streams and maintain a synchronization among the plurality of video streams as much as possible, encapsulating the video content captured by the first device to obtain the first video stream may include: encapsulating the video content captured by the first device based on a smart media transport (SMT) protocol to obtain the first video stream.

Parsing and synchronizing the first video stream and the second video stream to generate the multi-view video data may include: parsing and synchronizing the first video stream and the second video stream based on the SMT protocol to generate the multi-view video data, where the second video stream is obtained by encapsulating the video content captured by the second device based on the SMT protocol.

The SMT protocol is a packet-switched multimedia transport protocol and is an application-layer transport protocol. The SMT protocol has strong advantages in providing transmission and distribution services for media data in heterogeneous networks including unidirectional and bidirectional networks. The SMT protocol may support efficient distribution and transmission of media data including time-sequential media data (such as video and audio), non-time-sequential media data (such as text and images), and user feedback data (such as real-time commands).

In some embodiments, capturing capabilities of the first device and at least one second device may be combined, and the SMT protocol may be utilized to capture the multi-view video. While achieving multi-view video capturing, the time delay of the plurality of video streams is reduced.

The first device, after starting video recording, may perform video capturing, and encapsulate the captured video content based on the SMT protocol to obtain the first video stream. That is, the first device may perform video acquisition, compression, and streaming processing to obtain the first video stream data in a format compliant with a requirement of the SMT protocol. The second device may also encapsulate the captured video content based on the SMT protocol to obtain the second video stream and transmit the second video stream to the first device. The first device may receive the second video stream transmitted by the second device, and then parse and synchronize the first video stream and the second video stream based on a synchronization mechanism of the SMT protocol to generate the multi-view video data.

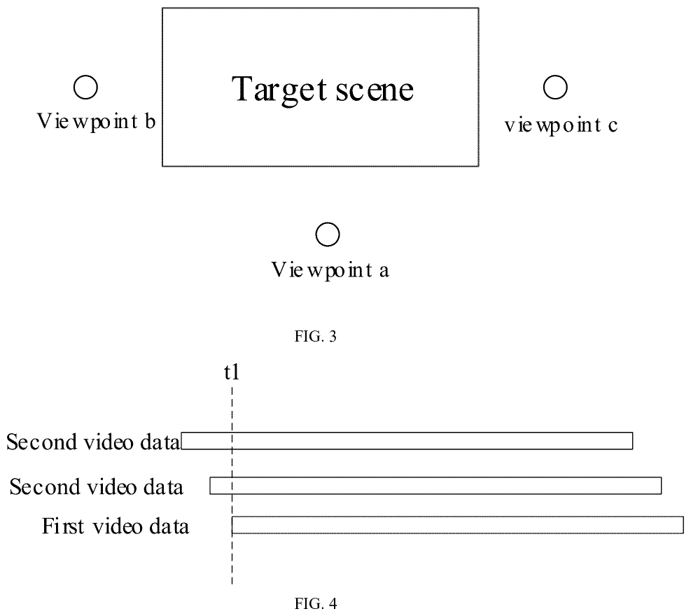

As shown in FIG. 2, FIG. 2 is a schematic scenario view of a video data processing method according to some embodiments of the present disclosure. A user may set three electronic devices for capturing, where a first device A may capture a target scene from a viewpoint a, a second device B1 may capture the target scene from a viewpoint b, and a second device B2 may capture the target scene from a viewpoint c. A Positional relationship among the viewpoint a, the viewpoint b, and the viewpoint c is shown in FIG. 3. The first device A may capture the target scene from the viewpoint a to obtain the first video stream. The second device B1 and the second device B2 may encapsulate the captured video content respectively into second video streams according to provisions of the SMT protocol and transmit the second video streams to the first device A. The first device A may parse and synchronize the three video streams according to the SMT protocol to generate the multi-view video data.

For example, in some embodiments, parsing and synchronizing the first video stream and the second video stream to generate the multi-view video data may include: parsing the first video stream to obtain the first video data, and parsing the second video stream to obtain the second video data; synchronizing the first video data and the second video data; and generating the multi-view video data based on synchronized first video data and synchronized second video data.

In some embodiments, the first device may parse the first video stream to obtain the first video data, and parse the second video stream to obtain the second video data. Since a start time of capturing by the first device and a start time of capturing by the second device may be different, the first video stream and the second video stream may not be completely synchronized. Therefore, after obtaining the first video data and the second video data, the first device may synchronize the first video data and the second video data, or align the first video data and the second video data on a time axis, so that a time difference between of an image of the first video data and an image of the second video data during a synchronized playback of the first video data and the second video data is as small as possible. As shown in FIG. 4, FIG. 4 is a schematic view of a method of aligning first video data and second video data according to some embodiments of the present disclosure. Assuming that the first video data is the latest to start capturing, then after alignment, a start time t1 of the first video data may correspond to a certain moment after the start time of the second video data.

After completing the synchronization of the first video data and the second video data, the multi-view video data may be generated based on the first video data and the second video data. The multi-view video data may be video data including a plurality of video streams, where switching among the plurality of video streams may be performed during playback.

In some embodiments, the first video stream may be a first video encapsulation unit sequence, and the second video stream may be a second video encapsulation unit sequence. The first video encapsulation unit may have a first absolute timestamp, and the second video encapsulation unit may have a second absolute timestamp.

Parsing the first video stream to obtain the first video data and parsing the second video stream to obtain the second video data may include: parsing the first video encapsulation unit sequence to obtain the first video data and the first absolute timestamp, and parsing the second video encapsulation unit sequence to obtain the second video data and the second absolute timestamp. Synchronizing the first video data and the second video data may include: synchronizing the first video data and the second video data based on the first absolute timestamp and the second absolute timestamp.

For example, the first device may encapsulate the captured video content into the first video stream according to the SMT protocol, where the first video stream is a first video encapsulation unit sequence. The first video encapsulation unit sequence may include a plurality of first video encapsulation units arranged in a chronological order of capture. Similarly, the second device may encapsulate the captured video content into the second video stream according to the SMT protocol, where the second video stream is a second video encapsulation unit sequence. The second video encapsulation unit sequence may include a plurality of second video encapsulation units arranged in a chronological order of capture. A video encapsulation unit may be a minimum media encapsulation unit defined by the SMT protocol, and each video encapsulation unit may have a corresponding absolute timestamp. The absolute timestamp may not be changed by any external force or observer. For example, the absolute timestamp of a certain video encapsulation unit may be “2022 Aug. 13 14:16:43,” indicating a shooting time of a starting frame of the video encapsulation unit. One video encapsulation unit may include one or more video frames.

The first device may parse the first video encapsulation unit sequence according to the SMT protocol to obtain one or more video frames included in each of the plurality of first video encapsulation units. The first video data includes the video frames in sequence. In addition, after parsing the first video encapsulation unit sequence, the first device may also obtain the first absolute timestamp of the first video data. Similarly, the first device may parse the second video encapsulation unit sequence according to the SMT protocol to obtain the second video data and the second absolute timestamp.

Next, the first device may synchronize the first video data and the second video data based on the first absolute timestamp and the second absolute timestamp. For example, video frames corresponding to the first absolute timestamp and the second absolute timestamp with the smallest difference may be aligned.

In some embodiments, the second video stream may carry, in addition to the absolute timestamp, a network transmission protocol, such as a user datagram protocol (UDP), to indicate a network transmission protocol configured for communication between the second device and the first device corresponding to the second video stream.

In some embodiments, generating the multi-view video data based on the synchronized first video data and synchronized second video data may include: obtaining a relative positional relationship between the second device and the first device; determining an arrangement order of the first video data and the second video data according to the relative positional relationship between the second device and the first device; and generating the multi-view video data based on the synchronized first video data and the synchronized second video data and the arrangement order.

In some embodiments of the above embodiments, the first device may provide an interface for viewing devices connected to the same Wi-Fi hotspot as the first device. In some embodiments, the user may also annotate a positional relationship between the second device and the first device on the interface. The relative positional relationship may be configured to indicate the arrangement order among the plurality of video streams in the multi-view video, so that the user may perform viewpoint switching when viewing the multi-view video. The first device may determine which of the other video streams to switch to for playback based on the relative positional relationship.

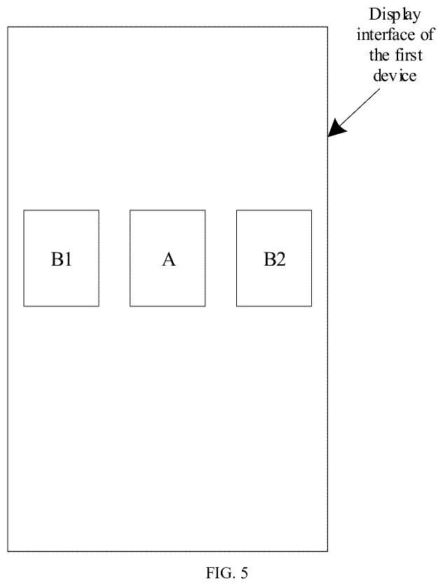

Taking the scenario shown in FIG. 2 as an example, suppose the user uses three mobile phones for capturing, namely A, B1, and B2. The user may drag an icon of A or an icon of B1 or an icon of B2 on the interface according to the viewpoints of the three devices to adjust their relative positions, so that the arrangement order of the three devices matches their actual placement, as shown in FIG. 5. FIG. 5 is a schematic view of a representation of a relative positional relationship between a first device and a second device according to some embodiments of the present disclosure. After the adjustment is completed by the user, the first device may determine the relative positional relationship between each second device and the first device based on the position relationships of the three icons, and may further determine the arrangement order of the first video data and the second video data based on the relative positional relationship between each second device and the first device. The relative positional relationship between the video data may be consistent with that between the corresponding devices. After the synchronization is completed, the multi-view video data may be generated based on the synchronized first video data and second video data and the arrangement order.

Next, an application scenario of some embodiments of the present disclosure is described. For example, if a user wants to shoot a basketball game, a plurality of mobile phones may be placed at a plurality of positions around the court, and communication connections may be established between the plurality of mobile phones. One of the plurality of mobile phones may be set as the host, and the others may be determined as auxiliary devices. The plurality of mobile phones may capture the basketball game from different viewpoints. As another example, when a fitness blogger conducts a live broadcast, a mobile phone may be placed respectively in a front position, a rear position, a left position, and a right position to capture from four angles. One of the mobile phones may be set as the host, and the others may be determined as auxiliary devices. After the video contents captured by the auxiliary devices are converted into video streams conforming to the SMT protocol, the video streams may be transmitted to the host. The host may parse the plurality of video streams to obtain the plurality of video data streams, and generate the multi-view video data based on the plurality of video data streams.

During implementation, the present disclosure may not be limited by the execution order of the operations described. Without causing conflicts, some operations may also be performed in other orders or simultaneously.

As can be seen from the above, the video data processing method in some embodiments of the present disclosure may be applied to the first device. The first device may establish the communication connection with the second device. The first device may encapsulate the video content captured by the first device to obtain the first video stream, and receive the second video stream sent by the second device. The second video stream may be obtained by encapsulating the video content captured by the second device. Then, the first device may parse and synchronize the first video stream and the second video stream to generate the multi-view video data. By means of the technical solution of some embodiments of the present disclosure, the capturing capabilities of a plurality of devices may be combined to realize multi-view video capturing.

In some embodiments, there may be a plurality of second devices. Before encapsulating the video content captured by the first device to obtain the first video stream, the method may further include: determining whether the first device supports a capturing function; in a case where the first device supports the capturing function, executing encapsulating the video content captured by the first device to obtain the first video stream; otherwise, receiving a plurality of second video streams sent by the plurality of second devices, and parsing and synchronizing the plurality of second video streams to generate the multi-view video data.

In the technical solution of some embodiments of the present disclosure, the first device may establish a communication connection with each of the plurality of second devices. It may first be determined whether the first device supports the capturing function. In a case where the first device supports the capturing function, the multi-view video data may be generated according to blocks 101 to 103 as described above. In a case where the first device does not support the capturing function, the first device may be configured only as a receiving and processing device for video stream data. The first device may receive the plurality of second video streams sent by the plurality of second devices, and parse and synchronize the plurality of second video streams to generate the multi-view video data. Methods of parsing and synchronization are the same as that for the first video stream and the second video stream described above, which will not be repeated here.

In some embodiments, after generating the multi-view video data based on the synchronized first video data and synchronized second video data and the arrangement order, the method may further include the following operations.

The first video data may be played; or, the first video data and the second video data may be played in split-screen.

The playback of the multi-view video data in some embodiments of the present disclosure may be a preview playback during the capturing process, or a playback after the capturing is completed.

For example, after obtaining the multi-view video data, the first device may play the first video data on a current capturing preview interface. Alternatively, the current capturing preview interface may display a plurality of playback windows, and the first video data and the second video data may be played in split-screen in the plurality of playback windows respectively, so that the user may view shooting images on the host and the auxiliary devices in real time during the capturing process.

In some embodiments, after playing the first video data, the method may further include: in a case where a viewpoint switching instruction is detected, determining target video data from the plurality of second video data according to the arrangement order; determining a first playback time point of the first video data, and determining a second playback time point in the target video data corresponding to the first playback time point, and playing the target video data from the second playback time point.

During the playback of the first video data, in a case where the viewpoint switching instruction is detected, the target video data may be determined from the plurality of second video data according to the previously obtained arrangement order of the plurality of video streams. The viewpoint switching instruction may indicate a switching direction. For example, an arrangement as shown in FIG. 5, in a case where the viewpoint switching instruction indicates switching in a left direction, the current first video data may be switched to the second video data captured by B1; in a case where the viewpoint switching instruction indicates switching in a right direction, current first video data may be switched to the second video data captured by B2. In addition, the three video data streams may have been aligned. During the switching process, a current playback time point of the first video data may first be determined as the first playback time point, and then the second playback time point in the target video data corresponding to the first playback time point may be determined. When switching to the target second video data, the playback may start from the second playback time point of the target video data, so that the synchronization may be maintained during the switching playback between the two videos.

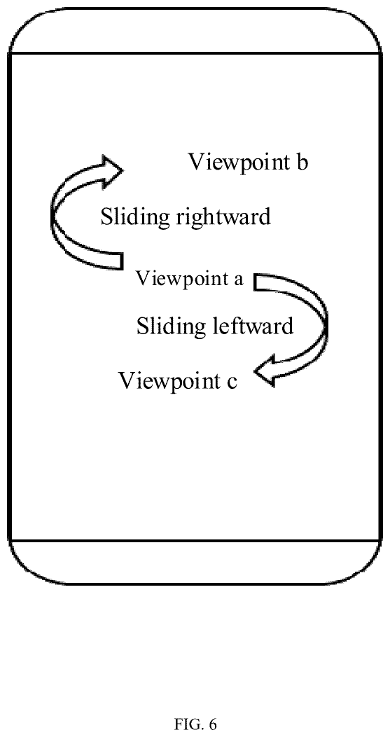

There may be a plurality of triggering manners of the viewpoint switching instruction. For example, in some embodiments, the method may further include: in a case where a touch sliding operation is detected, determining a sliding direction of the touch sliding operation; generating a viewpoint switching instruction matching the sliding direction. As shown in FIG. 6, when the first device plays the first video data from the viewpoint a, the user may trigger a rightward touch sliding operation on a display screen. The first device may generate the viewpoint switching instruction matching the sliding direction according to the sliding direction of the touch sliding operation. The viewpoint switching instruction may control the first device to switch to the second video data from the viewpoint b for playback. Conversely, in a case where the user triggers a leftward touch sliding operation on the display screen, the first device may generate a viewpoint switching instruction matching the sliding direction according to the sliding direction of the touch sliding operation. The viewpoint switching instruction may control the first device to switch to the second video data from the viewpoint c for playback.

The sliding directions described in some embodiments may be merely for illustrative purposes. The user may predefine the correspondence between sliding directions and video switching directions as needed.

In some embodiments, the method may further include: obtaining a movement distance and a movement direction detected by a displacement sensor; in a case where the movement distance is greater than a predetermined threshold, generating a viewpoint switching instruction matching the movement direction.

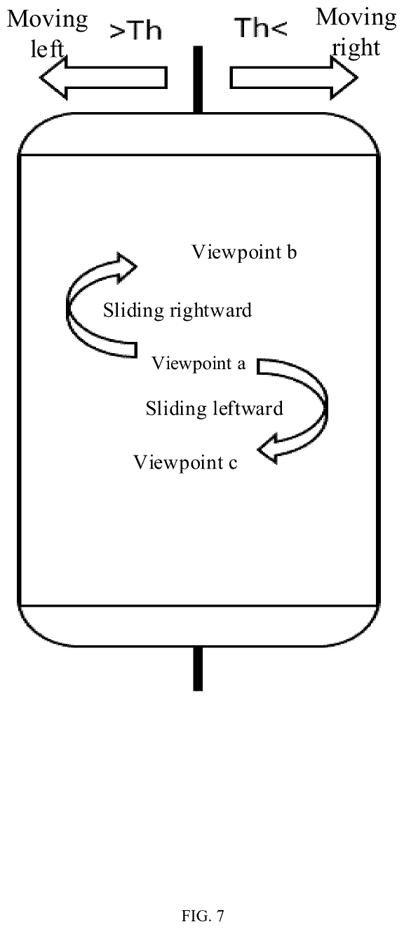

Taking the playback of the multi-view video by the first device as an example, during playback of the first video data, the user may trigger a viewpoint switching instruction by panning the first device. The first device may obtain the movement distance and the movement direction detected by the displacement sensor. When the detected movement distance exceeds a predetermined threshold Th, a viewpoint switching instruction matching the movement direction may be generated. As shown in FIG. 7, when the first device is playing the first video data from viewpoint a, in a case where it is detected that the rightward movement of the first device exceeds the predetermined threshold Th, a viewpoint switching instruction may be generated, which controls the first device to switch to the second video data from viewpoint b for playback. Conversely, in a case where the leftward movement of the first device exceeds the predetermined threshold Th, a viewpoint switching instruction may be generated, which controls the first device to switch to the second video data from viewpoint c for playback.

Through the video data processing method of the above embodiments, not only is multi-view video capturing implemented on intelligent terminals, thereby reducing the difficulty of multi-view video capturing, but also a simplified multi-view video playback mode is achieved by utilizing interaction methods such as touchscreen sliding and displacement sensing of intelligent terminals.

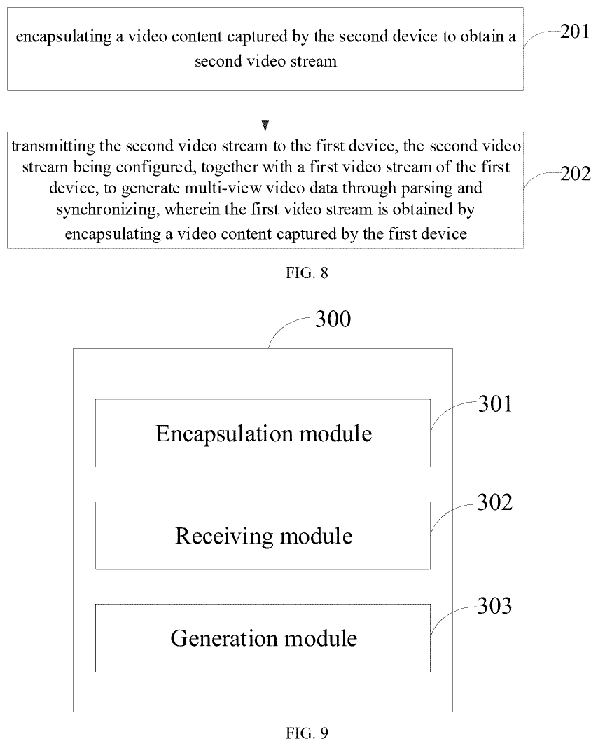

As shown in FIG. 8, FIG. 8 is a schematic flowchart of a video data processing method according to some embodiments of the present disclosure. Some embodiments of the present disclosure also provide a video data processing method applied to a second device. The method may include operations executed by the following blocks.

At block 201, a video content captured by the second device may be encapsulated to obtain a second video stream.

At block 202, the second video stream may be transmitted to a first device, and the second video may be configured together with a first video stream of the first device to generate multi-view video data through parsing and synchronizing, where the first video stream may be obtained by encapsulating a video content captured by the first device.

In some embodiments, the second video stream may be a second video encapsulation unit sequence. Encapsulating the video content captured by the second device to obtain the second video stream may include: encapsulating the video content captured by the second device based on a SMT protocol to obtain a second video encapsulation unit sequence, where each second video encapsulation unit has a second absolute timestamp.

The implementation process of the various embodiments of the method is detailed in the embodiments of the video data processing method, which will not be repeated here.

In some embodiments, a video data processing apparatus is further provided. As shown in FIG. 9, FIG. 9 is a schematic structural view of a video data processing apparatus according to some embodiments of the present disclosure. The video data processing apparatus 300 may be applied to the first device. The video data processing apparatus 300 may include an encapsulation module 301, a receiving module 302, and a generation module 303, which are detailed as follows.

The encapsulation module 301 may be configured to encapsulate a video content captured by the first device to obtain a first video stream.

The receiving module 302 may be configured to receive a second video stream sent by a second device, where the second video stream may be obtained by encapsulating a video content captured by the second device.

The generation module 303 may be configured to parse and synchronize the first video stream and the second video stream to generate multi-view video data.

In some embodiments, the apparatus may further include a determination module. The determination module may be configured to determine whether the first device supports a capturing function. In a case where the first device supports the capturing function, the encapsulation module 301 may encapsulate the video content captured by the first device to obtain the first video stream. In a case where the first device does not support the capturing function, the receiving module 302 may receive a plurality of second video streams sent by a plurality of second devices, and the plurality of second video streams may be parsed and synchronized to generate the multi-view video data.

The generation module 303 may be configured to parse the first video stream to obtain the first video data, and to parse the second video stream to obtain the second video data; to synchronize the first video data and the second video data; and to generate the multi-view video data based on synchronized first video data and synchronized second video data.

In some embodiments, the first video stream may be a first video encapsulation unit sequence, and the second video stream may be a second video encapsulation unit sequence. The first video encapsulation unit may have a first absolute timestamp, and the second video encapsulation unit may have a second absolute timestamp. The generation module 303 may be configured to parse the first video encapsulation unit sequence to obtain first video data and the first absolute timestamp, and parse the second video encapsulation unit sequence to obtain second video data and the second absolute timestamp. Synchronizing the first video data and the second video data may include: synchronizing the first video data and the second video data based on the first absolute timestamp and the second absolute timestamp.

In some embodiments, the generation module 303 may be further configured to obtain a relative positional relationship between the second device and the first device; determine an arrangement order of the first video data and the second video data according to the relative positional relationship between the second device and the first device; and generate the multi-view video data based on the synchronized first video data and the synchronized second video data and the arrangement order.

In some embodiments, the device may further include a playback module. The playback module may be configured to: play the first video data; or play the first video data and the second video data in split-screen.

In some embodiments, the playback module may be configured to: in a case where a viewpoint switching instruction is detected, determine target video data from the second video data according to the arrangement order; determine a first playback time point of the first video data, and determine a second playback time point in the target video data corresponding to the first playback time point, and play the target video data from the second playback time point.

In some embodiments, the playback module may be configured to: in a case where a touch sliding operation is detected, determine a sliding direction of the touch sliding operation; and generate a viewpoint switching instruction matching the sliding direction.

In some embodiments, the playback module may be configured to: obtain a movement distance and a movement direction detected by a displacement sensor; and in a case where the movement distance is greater than a predetermined threshold, generate a viewpoint switching instruction matching the movement direction.

In some embodiments, the first device and the second device may be connected to a same local area network; or the first device may establish a connection with the second device via a server.

The video data processing apparatus provided in the embodiments of the present disclosure and the video data processing method in the above embodiments belong to the same concept. Any method provided in the embodiments of the video data processing method may be implemented through the video data processing apparatus. The specific implementation process is detailed in the embodiments of the video data processing method, which will not be repeated here.

As can be seen from the above, the video data processing apparatus in some embodiments of the present disclosure may be applied to the first device. The first device may establish the communication connection with the second device. The first device may encapsulate the video content captured by the first device to obtain the first video stream, and receive the second video stream sent by the second device. The second video stream may be obtained by encapsulating the video content captured by the second device. Then, the first device may parse and synchronize the first video stream and the second video stream to generate the multi-view video data. By means of the technical solution of some embodiments of the present disclosure, the capturing capabilities of a plurality of devices may be combined to realize multi-view video capturing.

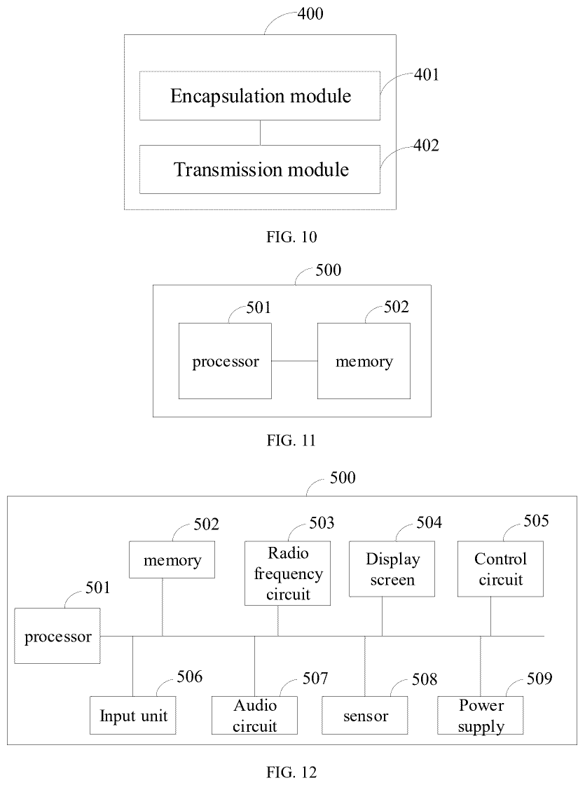

The embodiments of the present disclosure also provide a video data processing apparatus applied to a second device. As shown in FIG. 10, FIG. 10 is a schematic structural view of a video data processing apparatus according to some embodiments of the present disclosure. The video data processing apparatus 400 may be applied to the second device. The video data processing apparatus 400 may include an encapsulation module 401 and a transmission module 402, which are detailed as follows.

The encapsulation module 401 may be configured to encapsulate a video content captured by the second device to obtain a second video stream.

The transmission module 402 may be configured to transmit the second video stream to the first device, and the second video stream may be configured, together with a first video stream of the first device, to generate multi-view video data through parsing and synchronizing, where the first video stream may be obtained by encapsulating the video content captured by the first device.

The embodiments of the present disclosure also provide an electronic device. The electronic device may be a smart phone, a tablet computer, or other devices. As shown in FIG. 11, FIG. 11 is a schematic structural view of an electronic device according to some embodiments of the present disclosure. The electronic device 500 may include a processor 501 and a memory 502. The processor 501 may be electrically connected to the memory 502.

The processor 501 may be a control center of the electronic device 500. The processor 501 may connect various parts of the electronic device through various interfaces and circuits, and may perform various functions and data processing of the electronic device by running or calling a computer program stored in the memory 502 and calling data stored in the memory 502, thereby performing overall control of the electronic device.

The memory 502 is used to store computer programs and data. The computer programs stored in the memory 502 contain instructions executable by the processor. The computer programs may form various functional modules. The processor 501 executes various functional applications and data processing by calling the computer programs stored in the memory 502.

In some embodiments, the processor 501 in the electronic device 500 may perform the following operations to load an instruction corresponding to one or more computer program processes into the memory 502, and run the computer programs stored in the memory 502 by the processor 501, thereby implementing various functions as follows.

A video content captured by a first device may be encapsulated to obtain a first video stream.

A second video stream sent by the second device may be received, where the second video stream may be obtained by encapsulating a video content captured by the second device.

The first video stream and the second video stream may be parsed and synchronized to generate multi-view video data.

Alternatively, the processor 501 of the electronic device 500 may perform the following operations to load an instruction corresponding to one or more computer program processes into the memory 502, and run the computer programs stored in the memory 502 by the processor 501, thereby implementing various functions as follows.

A video content captured by the second device may be encapsulated to obtain a second video stream.

The second video stream may be transmitted to a first device, and the second video may be configured together with a first video stream of the first device to generate multi-view video data through parsing and synchronizing, where the first video stream may be obtained by encapsulating a video content captured by the first device.

In some embodiments, as shown in FIG. 12, FIG. 12 is a schematic structural view of an electronic device according to some embodiments of the present disclosure. The electronic device 500 may further include a radio frequency circuit 503, a display screen 504, a control circuit 505, an input unit 506, an audio circuit 507, a sensor 508, and a power supply 509. The processor 501 may be electrically connected to the radio frequency circuit 503, the display screen 504, the control circuit 505, the input unit 506, the audio circuit 507, the sensor 508, and the power supply 509, respectively.

The radio frequency circuit 503 may be configured to send and receive a radio frequency signal for a wireless communication with network devices or other electronic devices.

The display screen 504 may be configured to display information input by the user or provided to the user, as well as various graphical user interfaces of the electronic device. The graphical user interfaces may include an image, text, an icon, a video, or any combination thereof.

The control circuit 505 may be electrically connected to the display screen 504 and may be configured to control the display of information on the display screen 504.

The input unit 506 may be configured to receive input of a number, character information, or user feature information (such as a fingerprint), and generate a keyboard, a mouse, a joystick, an optical, or trackball signal input related to user settings and functional control. The input unit 506 may include a fingerprint recognition module.

The audio circuit 507 may provide an audio interface between the user and the electronic device through a speaker and a microphone. The audio circuit 507 may include a microphone. The microphone may be electrically connected to the processor 501. The microphone may be configured to receive voice information input by the user.

The sensor 508 may be configured to collect external environment information. The sensor 508 may include one or more of an ambient light sensor, an accelerometer, a gyroscope, and other sensors.

The power supply 509 may be configured to supply power to the various components of the electronic device 500. In some embodiments, the power supply 509 may be logically connected to the processor 501 through a power management system, so as to implement charging management, discharging management, and power consumption management functions through the power management system.

Although not shown in the drawings, the electronic device 500 may further include a camera, a Bluetooth module, etc., which will not be described in detail here.

In some embodiments, the processor 501 of the electronic device 500 may perform the following operations to load an instruction corresponding to one or more computer program processes into the memory 502, and run the computer programs stored in the memory 502 by the processor 501 to implement various functions as follows.

A video content captured by a first device may be encapsulated to obtain a first video stream.

A second video stream sent by the second device may be received, where the second video stream may be obtained by encapsulating a video content captured by the second device.

The first video stream and the second video stream may be parsed and synchronized to generate multi-view video data.

Alternatively, the processor 501 of the electronic device 500 may perform the following operations to load an instruction corresponding to one or more computer program processes into the memory 502, and run the computer programs stored in the memory 502 by the processor 501, thereby implementing various functions as follows.

A video content captured by the second device may be encapsulated to obtain a second video stream.

The second video stream may be transmitted to a first device, and the second video may be configured together with a first video stream of the first device to generate multi-view video data through parsing and synchronizing, where the first video stream may be obtained by encapsulating a video content captured by the first device.

As can be seen from the above, the electronic device in some embodiments of the present disclosure may establish the communication connection with the second device. The electronic device may encapsulate the video content captured by the first device to obtain the first video stream, and receive the second video stream sent by the second device. The second video stream may be obtained by encapsulating the video content captured by the second device. Then, the electronic device may parse and synchronize the first video stream and the second video stream to generate the multi-view video data. By means of the technical solution of some embodiments of the present disclosure, the capturing capabilities of a plurality of devices may be combined to realize multi-view video capturing.

The embodiments of the present disclosure further provide a computer-readable storage medium. A computer program may be stored in a computer-readable storage medium, and when the computer program is executed on a computer, the computer may execute the video data processing method according to any one of the above embodiments.

Those skilled in the art may understand that all or part of the steps in the various methods of the above embodiments may be instructed by a computer program to be completed by relevant hardware. The computer program may be stored in a computer-readable storage medium. The computer-readable storage medium may include, but is not limited to: a read only memory (ROM), a random access memory (RAM), a magnetic disk, or an optical disk, etc.

In addition, the terms “first,” “second,” and “third” in the present disclosure are used to distinguish different objects, rather than to indicate a particular order. Furthermore, the terms “comprise” and “have,” and any variations thereof, are intended to cover non-exclusive inclusion. For example, a process, a method, a system, a product, or a device that comprises a series of steps or modules is not limited to only those listed steps or modules, but may include other steps or modules not listed, or may also include inherent steps or modules of the process, method, product, or device.

The video data processing method, the video data processing apparatus, the storage medium, and the electronic device provided in the embodiments of the present disclosure have been described in detail above. The principles and embodiments of the present disclosure have been illustrated by way of specific examples. The description of the above embodiments is merely to assist in understanding the method and core idea of the present disclosure. Meanwhile, for those skilled in the art, modifications may be made to the specific implementation manners and application scopes based on the idea of the present disclosure. Therefore, the content of the present specification should not be construed as a limitation to the present disclosure.

1. A video data processing method, applied to a first device, the first device establishing a communication connection with a second device, the method comprising:
encapsulating a video content captured by the first device to obtain a first video stream;
receiving a second video stream sent by the second device, the second video stream being obtained by encapsulating a video content captured by the second device; and
parsing and synchronizing the first video stream and the second video stream to generate multi-view video data.

2. The method according to claim 1, wherein there are a plurality of second devices; before the encapsulating the video content captured by the first device to obtain the first video stream, the method further comprises:
determining whether the first device supports a capturing function;
in a case where the first device supports the capturing function, executing encapsulating the video content captured by the first device to obtain the first video stream;
otherwise, receiving a plurality of second video streams sent by the plurality of second devices, and parsing and synchronizing the plurality of second video streams to generate the multi-view video data.

3. The method according to claim 1, wherein the parsing and synchronizing the first video stream and the second video stream to generate the multi-view video data comprises:
parsing the first video stream to obtain first video data, and parsing the second video stream to obtain second video data;
synchronizing the first video data and the second video data; and
generating the multi-view video data based on synchronized first video data and synchronized second video data.

4. The method according to claim 3, wherein the first video stream is a first video encapsulation unit sequence, the second video stream is a second video encapsulation unit sequence, the first video encapsulation unit has a first absolute timestamp, and the second video encapsulation unit has a second absolute timestamp;
wherein the parsing the first video stream to obtain the first video data, and parsing the second video stream to obtain the second video data, comprises:
parsing the first video stream to obtain the first video data and the first absolute timestamp, and parsing the second video stream to obtain the second video data and the second absolute timestamp;
wherein the synchronizing the first video data and the second video data comprises:
synchronizing the first video data and the second video data based on the first absolute timestamp and the second absolute timestamp.

5. The method according to claim 4, wherein the synchronizing the first video data and the second video data based on the first absolute timestamp and the second absolute timestamp comprises:
aligning a video frame corresponding to the first absolute timestamp and a video frame corresponding to the second absolute timestamp having a smallest difference.

6. The method according to claim 3, wherein the generating the multi-view video data based on the synchronized first video data and the synchronized second video data comprises:
obtaining a relative positional relationship between the second device and the first device;
determining an arrangement order of the first video data and the second video data according to the relative positional relationship between the second device and the first device; and
generating the multi-view video data based on the synchronized first video data, the synchronized second video data and the arrangement order.

7. The method according to claim 6, wherein after generating the multi-view video data based on the synchronized first video data, the synchronized second video data and the arrangement order, the method further comprises:
playing the first video data;
or, playing the first video data and the second video data in split-screen.

8. The method according to claim 7, wherein the playing the first video data comprises:
playing the first video data on a current capturing preview interface;
wherein the playing the first video data and the second video data in split-screen comprises:
displaying a plurality of playback windows on the current capturing preview interface; and
playing the first video data and the second video data in split-screen in the plurality of playback windows respectively.

9. The method according to claim 7, wherein after playing the first video data, the method further comprises:
determining, in a case where a viewpoint switching instruction is detected, target video data from the second video data according to the arrangement order; and
determining a first playback time point of the first video data, and determining a second playback time point in the target video data corresponding to the first playback time point, and playing the target video data from the second playback time point.

10. The method according to claim 9, wherein the method further comprises:
determining, in a case where a touch sliding operation is detected, a sliding direction of the touch sliding operation; and
generating a viewpoint switching instruction matching the sliding direction.

11. The method according to claim 9, wherein the method further comprises:
obtaining a movement distance and a movement direction detected by a displacement sensor; and
generating, in a case where the movement distance is greater than a predetermined threshold, a viewpoint switching instruction matching the movement direction.

12. The method according to claim 1, wherein the first device and the second device are connected to a same local area network;
or, the first device establishes a connection with the second device via a server.

13. The method according to claim 1, wherein the encapsulating the video content captured by the first device to obtain the first video stream comprises:
encapsulating the video content captured by the first device based on a smart media transport (SMT) protocol to obtain the first video stream;
wherein the parsing and synchronizing the first video stream and the second video stream to generate the multi-view video data comprises:
parsing and synchronizing the first video stream and the second video stream based on the SMT protocol to generate the multi-view video data, wherein the second video stream is obtained by encapsulating the video content captured by the second device based on the SMT protocol.

14. The method according to claim 1, wherein before encapsulating the video content captured by the first device to obtain the first video stream, the method further comprises:
searching for a device connected to a same network hotspot as the first device, and displaying a found device on a user display interface; and
in response to a selection operation, determining a device indicated by the selection operation from a displayed device as the second device.

15. The method according to claim 4, wherein the parsing the first video stream to obtain the first video data, and parsing the second video stream to obtain the second video data, comprises:
parsing the first video encapsulation unit sequence according to an SMT protocol to obtain a plurality of video frames in sequence of the first video encapsulation unit sequence; and
parsing the second video encapsulation unit sequence according to the SMT protocol to obtain a plurality of video frames in sequence of the second video encapsulation unit sequence.

16. The method according to claim 4, wherein the second video stream further comprises a user datagram protocol (UDP) to indicate a network transmission protocol configured for a communication between the second device and the first device corresponding to the second video stream.

17. A video data processing method, applied to a second device, the second device establishing a communication connection with a first device, the method comprising:
encapsulating a video content captured by the second device to obtain a second video stream; and
transmitting the second video stream to the first device, the second video stream being configured, together with a first video stream of the first device, to generate multi-view video data through parsing and synchronizing, wherein the first video stream is obtained by encapsulating a video content captured by the first device.

18. The method according to claim 17, wherein the second video stream is a second video encapsulation unit sequence;
the encapsulating the video content captured by the second device to obtain the second video stream comprises:
encapsulating the video content captured by the second device based on an SMT protocol to obtain the second video encapsulation unit sequence, the second video encapsulation unit having a second absolute timestamp.

19. An electronic device, comprising a processor and a memory, the memory storing a computer program, and the processor being configured to execute a video data processing method comprising:
encapsulating a video content captured by a first device to obtain a first video stream;
receiving a second video stream sent by a second device, the second video stream being obtained by encapsulating a video content captured by the second device; and
parsing and synchronizing the first video stream and the second video stream to generate multi-view video data.

20. The electronic device according to claim 19, wherein there are a plurality of second devices; before the encapsulating the video content captured by the first device to obtain the first video stream, the method further comprises:
determining whether the first device supports a capturing function;
in a case where the first device supports the capturing function, executing encapsulating the video content captured by the first device to obtain the first video stream;
otherwise, receiving a plurality of second video streams sent by the plurality of second devices, and parsing and synchronizing the plurality of second video streams to generate the multi-view video data.
